(19) United States
(12) Patent Application Publication
(10) Pub. No.: US 2009/0112841 A1
(43) Pub. Date: Apr. 30, 2009

(54) DOCUMENT SEARCHING USING CONTEXTUAL INFORMATION LEVERAGE AND INSIGHTS

(75) Inventors: Murthy V. Devarakonda, Peekskill, NY (US); Nithya Rajamani, Shrub Oak, NY (US); James Rubas, Yorktown Heights, NY (US); Norbert G. Vogl, Mahopac, NY (US); Wlodek W. Zadrozny, Tarrytown, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/926,698

(22) Filed: Oct. 29, 2007

(51) Int. Cl. G06F 7/10

(52) U.S. Cl. 707/5; 707/E17.014

(57) ABSTRACT

A method and system are disclosed that enable a user to search a large collection of structured and unstructured documents using semantic concepts that the system provides to them, to search the most relevant business activity first, and then using one of the business activities as the additional context to search for specific document or documents that are most relevant. One aspect of the invention provides a methodology to perform concept-based structured search over document collections to obtain search results as business activities and associated relevant documents using the business activity context. The document collections are obtained by aggregating documents corresponding to a business activity. The instances are extracted from the document collections together with any concept-relationship specific heuristics in that domain. Another aspect of the invention enables the enterprise user to enter concepts and instances that define the search parameters using a structured user interface.

### BACKGROUND OF THE INVENTION

1. Field of the Invention

This invention generally relates to information searching, and more specifically, to methods and systems for searching for documents. Even more specifically, the preferred embodiment of the invention relates to such methods and systems using contextual information leverage and insights.

2. Background Art

In today's information-rich world, enterprise users have critical information needs to carry out their day-to-day jobs successfully. One such need is to identify the most relevant previous business activity based on a given criteria and then retrieve the most relevant documents within the collection of documents created during that prior business activity. In an enterprise, many coherent business activities take place as a part of conducting business. For example, a research project or a sales engagement, such as selling one hundred servers to ABC Company, are examples of business activities that create related collections of documents and these documents hold critical information that is specific to that particular business activity. The documents may be stored in several repositories distributed in the enterprise. The documents are a mix of structured and unstructured documents in different formats such as presentations, text documents, spreadsheets, emails, plain text and so on. This information content is typically unorganized for retrieval because the primary focus of the document creators is to carry out their business roles successfully—i.e. for sales executives, the foremost importance is to win the deal with the customers—rather than to organize the information themselves for reuse. Moreover, the same information at different levels of abstraction is relevant to different roles. So different parts of the information need to be extracted and organized in a relevant fashion for different roles. There might also be information security and [WZ] privacy requirements that define access rights based on different roles in an enterprise.

These complex requirements imply that a static approach to organizing information is ineffective. At the same time, manual processes are costly and time-consuming. What is needed in an enterprise is an automated extraction of relevant information from large unorganized and mostly unstructured data and a role based semantic search capability of this information content.

Prior art information-searching techniques generally fall into three categories: 1) keyword searches, (2) semantic concept-based searches, and (3) information portals.

Key word searching is embodied in numerous search engines available on the Internet today. When a user enters a set of words or phrases, links to web pages that contain one or more of the specified words are returned after prioritizing the list of web pages based on certain criteria such as the number of web pages linking to it. There is no explicit user role recognized by the search engines. There is no notion of business activity or the relationship between a web page and the activity that may have created the page.

Faceted searching is a refinement of keyword searching that allows “drill down” through search results, getting to more specific information. The “facets” (attributes) of the documents are dynamic and are organized as the vertices of a graph-based system. Still, this search system presents only a list of document results independent of a specific business activity.

U.S. Pat. No. 6,944,612 further refines keyword searching by way of a methodology to contextually cluster results for a collection of search engines. Here, the keyword queries are distributed to search engines, the search results (documents) are contextually clustered, and the resultant structure helps with knowledge discovery. Still the earlier stated problems associated with keyword searching and its results exist.

Procedures to build information management and retrieval applications using semantic concept-based techniques are taught in a paper by Ferrucci, et al. The paper teaches how documents can be annotated using heuristic methods to identify the occurrences of certain concepts, and how the search engines can leverage the annotations to retrieve documents with the implied conceptual meanings of the words.

U.S. Pat. No. 6,970,881 refines the concept-based search in the form of a methodology for categorizing and analyzing a set of unstructured information, wherein the natural language search query is analyzed and parsed into a set of seed concepts and the search system returns a set of documents that represents those concepts by searching over relational database. But still, in the procedure disclosed in U.S. Pat. No. 6,970,881, the search granularity is at an unstructured object (document) level and this patent does not provide a business-activity based search.

Information portals are well-known systems of highly structured web pages organized to provide specific information for a community of users. The information content is usually managed through updates and restructuring.

The prior art discussed above does not solve the specific information access problems of enterprise users because the techniques disclosed in the prior art results in information overload and also because the information is dispersed in bits and pieces among documents grouped under different attributes. There are no mechanisms in the prior art to guide the user directly to a record of business activity and then show the relevance of documents within that business activity.

### SUMMARY OF THE INVENTION

An object of this invention is to improve methods and systems for information searching.

Another object of the present invention is to guide a user directly to a previous business activity and then show the relevance of documents within that business activity.

A further object of the invention is to provide automated extraction of relevant information from large unorganized and mostly unstructured data and a role based semantic search capability of this information content.

Another object of the invention is to display the results of a search query in terms of entities and associated concept and instance pairs and relationships between concepts and contextually relevant documents.

An object of the invention is to search for documents by searching for the most relevant business activities first, and then using one of the business activities as additional context to search for a specific document or documents that are most relevant.

These and other objectives are attained with a method and system wherein users can search a large collection of structured and unstructured documents using semantic concepts that the system provides to them, to search the most relevant business activity first, and then using one of the business activities as the additional context, to search for specific document or documents that are most relevant.

One aspect of the invention provides a methodology to perform concept-based structured search over document collections and to obtain search results as business activities and associated relevant documents using the business activity context, such as afore mentioned sale of one hundred servers to ABC Co. The document collections are obtained by aggregating all documents corresponding to a business activity. The instances are extracted from the document collections together with any concept-relationship specific heuristics in that domain (domain knowledge or domain heuristic). Another aspect of the invention enables the enterprise user to enter concepts and instances that define the search parameters using a structured user interface. The search query could also be a natural language query (similar interface as that of keyword search), which can be parsed to get the associated concepts and instances.

One embodiment of the invention provides techniques including retrieving the business activities satisfying the search query (i.e. entities with the defined input instances), and displaying all the instances associated with the business activity relevant to the original concepts in the query and/or the enterprise user's role. This embodiment of the invention provides further, upon the user's interest in the business activity, using the business activity context to automatically issue semantic search queries to get the most relevant document results from the document collection associated with the business activity. One embodiment of the invention provides techniques to search and navigate from target concept and instance pairs to relevant document collections, and from document collections and context pairs to relevant documents in a collection. In contrast, a semantic search in the prior art is a technique only to search from target concept and instance pair to relevant documents and a keyword search in the prior art is a technique to search from target words to relevant documents.

Another aspect of the invention enables the display of the search results in terms of entities and associated concept and instance pairs and in terms of relationships between concepts and contextually relevant documents. One advantage of the disclosed invention is that the resulting information so retrieved and displayed is focused and actionable (i.e. assists decision making) as well as enables knowledge discovery.

The preferred embodiment of the invention, described below in detail, provides an innovative search and information leverage solution that combines knowledge extraction with semantic search and social networking analysis in a policy-driven fashion to satisfy the information needs of the business practitioners. This embodiment of the invention automatically tags or “annotates” the data and documents with the semantics and extracts key pieces of information that is identified to be the most valuable from the huge mass of structured and unstructured data that may not be organized exceptionally well. Once the information is extracted, it is fed into a structured repository (or a database). The context of the information extracted is recorded as well to make the information actionable and this comes from the domain knowledge and document metadata, if any.

In addition to allowing different views and visualization of this extracted knowledge base, policy-driven rules are executed to provide additional relevant information. This is done by means of utilizing the extracted knowledge in conjunction with the practitioner queries to drive a semantic search on the organized index of data and annotations. Policy rules are written appropriately to handle the confidentiality and privacy concerns in addition to access rights. Workflows are executed so that the extracted knowledge is sanitized and is ensured of non-confidential information. Social networking analysis done in this context and exposed with the extracted knowledge artifacts further boosts the usefulness factor of the exposed information. In this way, even if the practitioner is looking for additional pieces of information that is not exposed in the results, the option of contacting the key contacts is very useful.

The advantage of this approach is that it enables a focused view of key, actionable information from the huge collection of unorganized data and the level of information exposed is dependent on the practitioner role and policies setup in the system. It is not a binary decision depending on whether the practitioner has access to the entire document or not—but a more flexible approach to expose some key and relevant information, with pointers to contacts for getting further details and also additional relevant links if policies permit.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a document searching system embodying the present invention.

FIG. 2 shows a contextual information leverage model.

FIG. 3 is a flow chart showing a preferred searching procedure embodying this invention.

FIG. 4 shows a computer system that may be used to implement this invention.

### DETAILED DESCRIPTION OF THE PREFERRED EMBODIMENTS

In an enterprise, search for information is goal oriented, and the goals have an affinity towards some higher level business activity—examples of such activities could be a prospective sale of IT outsourcing services, a scheduled meeting for administrative assistants, a product sale for sales professionals in an IT firm, employee hiring activity for human resources personnel, etc. Each of these organized “business activities” possibly have associated structured and unstructured and/or unorganized documents, e.g. all documents related to a services deal, all documents related to a product sale, all documents related to an employee hiring etc. Each of these business activities also could have associated “concepts” (classes in generic Ontology terms) and “instances” (individuals in generic Ontology terms) and well-defined relationships between the various concepts. The concepts and instances associated with a business activity form its “context”. For any enterprise user, there can be a few of these business activities that are primary goals of information seeking related to their job function. Typical keyword, faceted or semantic searches performed directly on the document collection require the enterprise user to spend significant time to navigate through the results, read various documents and perform mental grouping of concepts, instances and their relationships to arrive at the desired set of documents.

The present invention, generally, provides a method and system that enables users to search a large collection of structured and unstructured documents using semantic concepts that the system provides to them, to search the most relevant business activity first, and then using one of the business activities as the additional context, to search for specific document or documents that are most relevant.

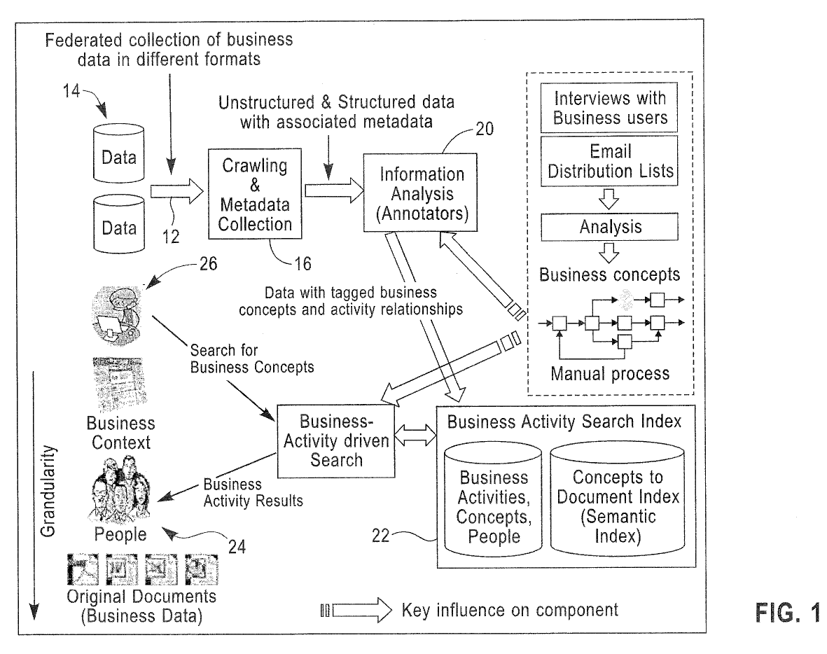

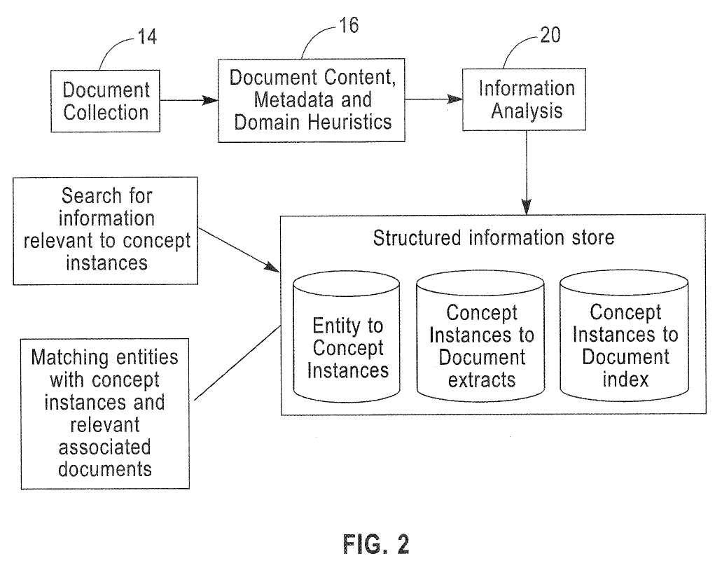

FIGS. 1 and 2 illustrate a preferred system embodying the present invention, and the following discussion is given with reference to these figures.

The first step 12 in the invention is to crawl the various repositories (teamrooms—repositories of documents created by a group of collaborating professionals, databases etc.,) 14 and get the collection of documents and any associated metadata, as represented at 16. The various formats (ppt,xls,doc etc.,) are converted to a text format (unicode representation) and this is fed into the next analysis component 20. Here is where the data and documents are tagged with associated semantics or “annotated” to enable semantic search on data. Aggregate level annotators are written to extract and collect key and valuable knowledge to be stored in a knowledge database 22. The semantic search index is also constructed from the text analysis and parsing. The business practitioner 24 logs in to the application and provides a natural language query that describes the information need and this is converted by query analyzer into a combination of SQL (Database Structured Query Language) queries. These SQL queries give some results and provide additional context for constructing relevant SIAPI (Search and Index API) queries. A part of the results returned include social networking information—with contact information for key practitioners involved with the underlying information. The SIAPI query gives a very relevant set of document links (governed and filtered by policy control). Policy control involves enforcing access rights at a basic document level, but more importantly provides higher-level abstractions of what knowledge is relevant and appropriate for the different roles. For example, a knowledge admin role 26 is given additional query interfaces like keyword searches, whereas a business practitioner might not be exposed to such an interface in fear of exposing a security hole to indirectly gain access to inappropriate details of information. Policies would also govern the relevancy of query concepts and parameters pertinent to the role.

For example, consider concepts C1, C2 . . . Cn in an enterprise domain; there could be several instances of a concept CI, let's call them I1, I2 . . . Ik. For example, in the Services business, a concept could be Service Offering and an associated instance could be Mainframe Management. Sometimes the concept-instance pairs are well known and standard, such as Service Offering and Mainframe Management, and sometimes the concept-instance pairs are unknown at query time e.g. Contractor and Vendor XYZ (hence it becomes knowledge discovery).

In the preferred embodiment, it is considered that the relevant document collection 14 logically belongs to a set of business activities D1, D2 . . . Dj. A set of concepts is identified through domain knowledge that is considered important for the end user roles. The document collection belonging to a business activity Di, is processed to extract a set of concepts and instances that are associated with that business activity using semantic search techniques based on the domain knowledge.

The semantic search techniques are described herein as applied from the previous art. The semantic analysis is based on various techniques ranging from simple to state-of-the-art, including regular expressions, domain heuristics based, semi-structured information analysis, ontologies, text classifiers and natural language processing.

The search solution is put together by innovatively combining the power of enterprise search with Semantic Indexing and Unstructured Information Management (UIM) platforms. The enterprise search components of crawling, parsing, indexing and search runtime are utilized as the search platform for the preferred embodiment of the invention. The annotators (semantic analysis components) automatically add “tags” to the documents stored in multiple repositories with the relevant semantics and extract key pieces of information that are identified to be valuable. Together, the semantic tags and information extracted by the annotators provide the business-activity context to the search. The annotators contain the analysis logic to identify which documents within the repositories are key in association with a business activity, and within those documents, what segments should be analyzed for retrieving the required information (e.g., details of a “win strategy”).

The information thus extracted is processed and integrated into a structured knowledge database, which forms the business activity index 22. This database contains information organized by the business activity, including extracted information associated with some key business concepts (that forms the business context for the activity), and people associated with the activity and the business context. In addition, the annotators also add semantic tags or annotations to relevant portions in the document text. The documents together with the annotations result in a semantic index. This analysis part of the system could be done offline. The online part of the system is comprised of a user interacting with the system by first retrieving a particular business activity (e.g., sales) with its business context, and then depending on his/her interest on the activity and access control privileges, the documents pertaining to the activity can be retrieved.

The users interact with the system using a User Interface (UI) that exposes business concepts. The user query is converted into a set of SQL queries on the business activity index first, and later semantic search queries to the semantic index. The SQL queries extract the first level results, which are business activities relevant to the user query; and for each business activity, it retrieves the business context of the activity (from the database itself) and relevant documents from the semantic index using semantic search queries within the scope of that activity. Hence when the user selects a business activity, the document links listed under that activity would be to the key documents that contributed to the relevance of that activity. This search technique is enabled by a combination of a knowledge database and a semantic index along with multiple semantic analysis techniques discussed above.

The principals used in the preferred embodiment of this invention are superior to facets in the faceted search prior art, because a facet is associated only with a particular document or document link in a typical search mechanism. With the present invention, a concept-instance pair may be associated with a business activity even if all of the individual documents in the document collection do not explicitly have the concept as a facet. And this exposes the relationships between the facets at the business activity level, which is the level at which information is desired. For example, consider a Services Sale belonging to Financial Services Sector and having Mainframe Service Offering. Here, the sale is the logical business activity having a document collection associated with it; and by processing one sub-section of the document collection and applying domain knowledge, we could derive the association of (Sector, Financial Services Sector) (concept, instance) in that business activity. Possibly by processing another non-overlapping sub-section of the document collection and applying yet another domain heuristic, we might derive the (Service Offering, Mainframe) (concept,instance) association for the same business activity. Though the instances corresponding to that business activity, Financial Services Sector and/or Mainframe, may not be facets of any particular document in the document collection of that business activity, the entire business activity is associated with these two instances, Financial Services Sector and Mainframe, and these relationships are displayed in the search results. Also, there are cases where (concept,instance) pair does not have to be a facet of any individual document in the document collection. By applying domain knowledge and heuristics across the document collection some inferences can be made to associate that (concept, instance) with the corresponding business activity. For example, we could derive the association of (Sector, Financial Services Sector) (concept, instance) in that business activity by processing the people information (people who took part in the business activity and their role) across the entire document collection.

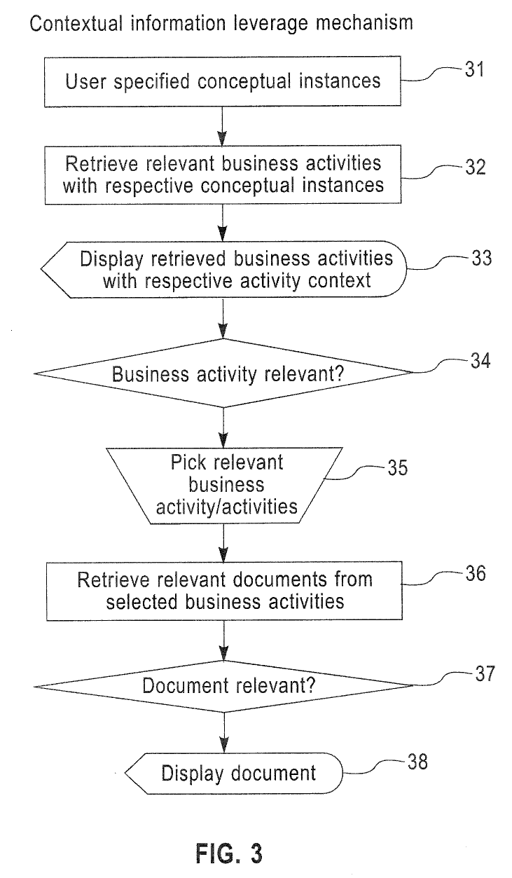

Now let us say an enterprise user is searching based on a few known concept-instance pairs i.e. searching for information relevant to concept, instance pairs (C1, I1), (C4, I4) and (C6, I6). With reference to FIG. 3, the method is comprised of, at step 31, first applying the search on the concept-instance pair to business activity associations and, at step 32, getting relevant business activities as search results. At step 33, the retrieved business activities are displayed with respective activity context.

For example, the search may return business activities D1, D3 and D8 with the respective instance associations given below. In the table and text below, the notation “In” when used in the context of a business activity, and implies that the concept-instance pair (Cn, In) is associated with the business activity.

| Business activity | Associated instances |
|---|---|
| D1 | I1, I2, I4, I5, I6, I10 |
| D3 | I1, I4, I5, I6, I9, I15 |
| D8 | I1, I3, I4, I6, I12 |

Not all document collections associated with D1, D3 and D8 are interesting and relevant to the user, and at step 34, the method determines if the business activity is relevant. What makes a business activity interesting and relevant (worth pursuing further) to a user is the concept-instance collection of (C1, I1), (C4, I4), (C6, I6), which the user entered in the search query and a collection of other important concept-instance pairs not specifically posed by the user, e.g. (C9, I9). In a complex enterprise environment, the decision regarding whether a business activity and the associated collection is relevant or not depends on user perceptions of complex relationships between these concepts. Enterprise users will be able to quickly judge based on the exposed context of a business activity. This is what makes the search results “focused” and “actionable”. At step 35, the user picks the relevant business activity or activities.

For novice enterprise users who are not well-versed in the business and therefore do not have a knowledge of the set of concepts that makes a business activity worthwhile considering, the disclosed method assists by providing the right set of concepts and hence the business activity context. For example, given a query corresponding to concept-instance pairs (C1, I1), (C4, I4) and (C6, I6), the preferred system determines that C9 is something very crucial in this business activity context and/or for the user role and automatically includes C9 in the results. An example would be that the enterprise user is searching for services engagements that have Mainframe Service Offering and Financial Services Sector, and this search results in multiple engagements being displayed. But a quick perusal of the engagement facts (concept, instance pairs) shows the result of the engagement—whether it was eventually won/lost/undecided and contract value. The user just decides to further pursue/navigate to the engagement that matches the expectation closest i.e. won engagements with a contract value of more than $500M i.e. with concept-instance pairs that satisfy (result—win) and (contract value—greater than $500M). At step 36, the relevant documents are retrieved from selected business activities; at step 37, the user selects the most relevant of these documents; and at step 38, the selected documents are displayed.

As will be readily apparent to those skilled in the art, the present invention, or aspects of the invention, can be realized in hardware, software, or a combination of hardware and software. Any kind of computer/server system(s)—or other apparatus adapted for carrying out methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

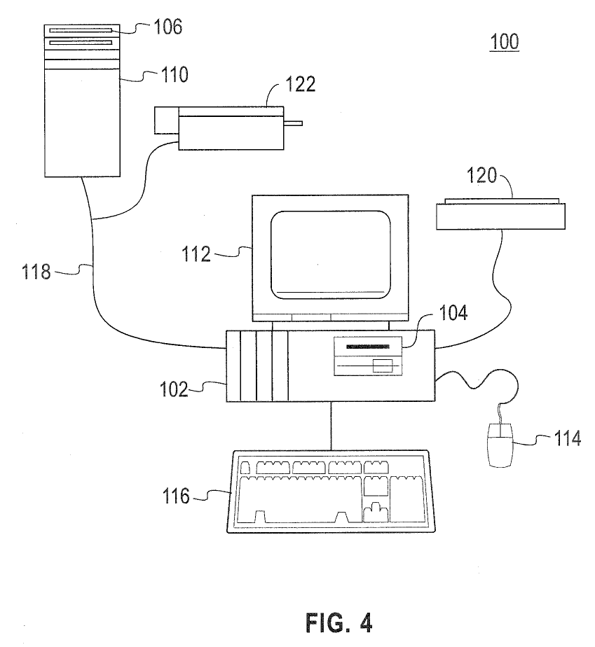

For example, FIG. 4 illustrates a computer system 100 which may be used in the implementation of the present invention may be carried out. Computer system includes a processing unit 102 that houses a processor, memory and other systems components that implement a general purpose processing system that may execute a computer program product comprising media, for example a floppy diskette that may be read by processing unit 102 through floppy drive 104.

The program product may also be stored on hard disk drives within processing unit 102 or may be located on a remote system 106 such as a server 110, coupled to processing unit 102, via a network interface, such as an Ethernet interface. Monitor 112, mouse 114 and keyboard 116 are coupled to processing unit 102, to provide user interaction. Scanner 120 and printer 122 are provided for document input and output. Printer 122 is shown coupled to processing unit 102 via a network connection, but may be coupled directly to the processing unit. Scanner 120 is shown coupled to processing unit 102 directly, but it should be understood that peripherals may be network coupled or direct coupled without affecting the ability of workstation computer 100 to perform the method of, or aspects of, the invention.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of searching documents for a user and using contextual information leverage and insights, the method comprising the steps of:
searching through a collection of documents using semantic concepts to identify a group of business activities; and
using one of said business activities as an additional context to identify one or more of the documents as relevant to the user.

2. A method according to claim 1, wherein the step of using one of said business activities further includes the steps of:
constructing a search query based on said one of the business activities; and
using said search query to identify said one or more documents.

3. A method according to claim 1, wherein the user has a defined role in a given enterprise, and wherein the step of constructing a search query includes the step of tailoring the search query to said defined role of the user in said enterprise.

4. A method according to claim 1, wherein the user has defined access privileges to the collection of documents, and wherein the step of using one of said business activities includes the steps of:
identifying a first set of documents using said search query;
restricting said set of documents based on the defined access privileges of the user to form a restricted set of documents; and
providing the user with said restricted set of documents.

5. A method according to claim 1, further comprising the steps of:
obtaining said collection of documents; and
tagging said collection of documents with semantics and annotations; and wherein:
the step of searching through the collection of documents includes the step of searching said semantics and annotations to identify relevant documents.

6. A method according to claim 5, wherein the step of searching through the collection of documents further includes the step of using said identified relevant documents to identify said group of business activities; and
the step of selecting one of the business activities includes the step of said user selecting one of said business activities.

7. A method according to claim 1, wherein the searching step includes the step of identifying a business activity concept.

8. A method according to claim 7, wherein the searching step further includes the step of extracting one or more instances of said concept from the collection of documents; and
the step of using one of said business activities includes the step of using said business activity concept and said extracted one or more instances to identify said one or more documents.

9. A method according to claim 1, wherein the document collection is obtained by aggregating documents relating to said group of business activities, and comprising the further step of displaying to the user all instances associated with the business activity relevant to the original concept in the user's role.

10. A method according to claim 1, wherein the using step includes the step of automatically issuing semantic search queries to get the most relevant documents results from the document collection associated with the business activity, and comprising the further step of displaying the search results in terms of entities and associated concept and instance pairs, and in terms of relationships between concepts and contextually relevant documents.

11. A system for searching documents for a user and using contextual information leverage and insights, the system comprising a processing unit including:
first computer readable program code for searching through a collection of documents using semantic concepts to identify a group of business activities; and
second computer readable program code for using one of said business activities as an additional context to identify one or more of the documents as relevant to the user.

12. A system according to claim 11, wherein the second computer readable code includes computer readable code for constructing a search query based on said one of the business activities, and using said search query to identify said one or more documents.

13. A system according to claim 11, wherein the user has a defined role in a given enterprise, and wherein the second computer readable code includes computer readable code for tailoring the search query to said defined role of the user in said enterprise.

14. A system according to claim 11, wherein the user has defined access privileges to the collection of documents, and wherein the second computer readable code includes computer readable code for identifying a first set of documents using said search query, restricting said set of documents based on the defined access privileges of the user to form a restricted set of documents, and providing the user with said restricted set of documents.

15. An article of manufacture comprising:
at least one computer usable medium having computer readable program code logic to search documents for a user and using contextual information leverage and insights, the computer readable program code logic comprising:
first searching logic for searching through a collection of documents using semantic concepts to identify a group of business activities; and
second searching logic for using one of said business activities as an additional context to identify one or more of the documents as relevant to the user.

16. An article of manufacture according to claim 15, wherein the second searching logic further includes logic for constructing a search query based on said one of the business activities, and for using said search query to identify said one or more documents.

17. An article of manufacture according to claim 15, wherein the user has a defined role in a given enterprise, and wherein the second searching logic includes logic for tailoring the search query to said defined role of the user in said enterprise.

18. A method of deploying a computer program product for searching documents for a user and using contextual information leverage and insights, wherein when executed, the computer program performs the steps of:
searching through a collection of documents using semantic concepts to identify a group of business activities; and
using one of said business activities as an additional context to identify one or more of the documents as relevant to the user.

19. A method of deploying a computer program product according to claim 18, wherein the step of using one of said business activities further includes the steps of:
constructing a search query based on said one of the business activities; and
using said search query to identify said one or more documents.

20. A method of deploying a computer program product according to claim 18, wherein the user has a defined role in a given enterprise, and wherein the step of constructing a search query includes the step of tailoring the search query to said defined role of the user in said enterprise.

21. A method of deploying a computer program product according to claim 18, wherein the user has defined access privileges to the collection of documents, and wherein the step of using one of said business activities includes the steps of:
identifying a first set of documents using said search query;
restricting said set of documents based on the defined access privileges of the user to form a restricted set of documents; and
providing the user with said restricted set of documents.

22. A method of searching documents for a user and using contextual information leverage and insights, the method comprising the steps of:
searching through a collection of documents using semantic concepts to identify a group of business activities;
selecting one of the business activities;
constructing a search query including said one of the business activities; and
using said search query to identify one or more documents as relevant to the user.

23. A method according to claim 22, wherein the document collection is obtained by aggregating documents relating to said group of business activities.

24. A method according to claim 22, comprising the further step of displaying to the user all instances associated with the business activity relevant to the original concept in the user's role.

25. A method according to claim 22, wherein the using step includes the step of automatically issuing semantic search queries to get the most relevant documents results from the document collection associated with the business activity, and comprising the further step of displaying the search results in terms of entities and associated concept and instance pairs, and in terms of relationships between concepts and contextually relevant documents.
